(19) United States
(12) Patent Application Publication
(10) Pub. No.: US 2009/0104435 A1
(43) Pub. Date: Apr. 23, 2009

(54) Method for Functionalizing Surfaces

(75) Inventors: James E. Hutchison, Eugene, OR (US); Christina E. Inman, Eugene, OR (US); Gregory J. Kearns, Eugene, OR (US); Evan W. Foster, Eugene, OR (US)

Correspondence Address: KLARQUIST SPARKMAN, LLP, 121 SW SALMON STREET, SUITE 1600, PORTLAND, OR, 97204, US

(73) Assignee: STATE OF OREGON ACTING BY AND THROUGH THE STATE BO, Eugene, OR (US)

(21) Appl. No.: 11/920,368

(22) PCT Filed: May 12, 2006
(86) PCT No.: PCT/US2006/018716

§ 371 Date: Nov. 13, 2007

Related U.S. Application Data
(60) Provisional application No. 60/680,919, filed on May 13, 2005.

(51) Int. Cl. B32B 5/16; B32B 15/04

(52) U.S. Cl. 428/328; 428/457; 428/323; 427/216; 977/883

(57) ABSTRACT

Disclosed is a method for the chemical modification of surfaces to form patterned nanoparticle arrays on the surfaces. Methods of producing arrays in predetermined patterns and electronic devices that incorporate such patterned arrays are also described.

### CROSS REFERENCE TO RELATED APPLICATION

This application claims the benefit of the earlier filing date of U.S. provisional patent application No. 60/680,919, filed May 13, 2005, which is incorporated herein by reference.

### ACKNOWLEDGEMENT OF GOVERNMENT SUPPORT

This invention was made with government support under Grant No. DGE-0114419 awarded by the National Science Foundation. The government has certain rights in the invention.

### FIELD

This application concerns patterning substrates and the formation of organized arrays of metal, alloy, semiconductor and/or magnetic nanoparticles on patterned surfaces, for use in various applications, including nanoelectronics, catalysis, sensors and optics.

### BACKGROUND

To scale electronic devices down to nanometer dimensions, fundamentally distinct new technologies are needed to provide smaller features that can confer heretofore unattainable electron flow control. The ultimate limit is a system in which the transfer of a single charge quantum corresponds to information transfer or some type of logic operation. Such single-electron systems are presently the focus of intense research activity. See, for example, Single Charge Tunneling, Coulomb Blockade Phenomena in Nanostructure, edited by H. Grabert and M. H. Devoret, NATO ASI Series B: Physics Vol. 294 (1992). These systems have potential application to nanoelectronic circuits that have integration densities far exceeding those of present day semiconductor technology. See, Quantum Transport in Ultrasmall Devices, edited by D. K. Ferry, H. L. Grubin, C. Jacoboni, and A. Jauho, NATO ASI Series B: Physics Vol. 342 (1995).

Single-electron transistors based on the concept of Coulomb blockade are one proposed technology for realizing ultra-dense circuits. Coulomb blockade is the suppression of single-electron tunneling into metallic or semiconductor islands. In order to achieve Coulomb blockade, the charging energy of an island must greatly exceed the thermal energy. To reduce quantum fluctuations the tunneling resistance to the island should be greater than the resistance quantum h/e². Coulomb blockade itself may be the basis of conventional logic elements, such as inverters.

Equally promising is the fact that the Coulomb blockade effect can be used to pump charges one-by-one through a chain of dots to realize a frequency-controlled current source in which the current is exactly equal to I=ef, where f is the clocking frequency.

While the operation of Coulomb blockade devices has been demonstrated, most operate only at greatly reduced temperatures and require sophisticated nanofabrication procedures. The size scales necessary for Coulomb blockade effects at such relatively elevated temperatures of about room temperature impose limits on the number, uniformity and connectivity of quantum dots. As a result, alternative methodologies of nanofabrication need to be investigated and developed.

The electronic properties of small metallic nanoparticles have been examined for application in nanoelectronics, catalysis, sensors and optics. However, few devices that incorporate such nanoparticles have been developed to date, in large part due to the inability to precisely control the anchoring and positioning of nanoparticles on a substrate. Prior approaches to nanoparticle deposition on surfaces typically have failed to provide the necessary control over nanoparticle size distribution, interparticle spacing, and/or are incompatible with semiconductor processing methods. Disclosed herein are methods to precisely and consistently manipulate nanoparticles and control their anchoring and positioning on a substrate. These methods enable the fabrication of electronic devices using nanoparticles.

### SUMMARY

The present disclosure describes nanoparticles, preparation of nanoparticles, arrays comprising nanoparticles, and embodiments of a method for using and electronic devices including such nanoparticles and arrays. Nanoparticles may be formed of metal, alloy, semiconductor and/or magnetic nanoparticle materials.

In one embodiment of the disclosure, patterned arrays of nanoparticles are disclosed. In one aspect, such nanoparticle arrays comprise a substrate, an oxophilic metal deposited on the substrate and a linker linking the oxophilic metal to a nanoparticle.

Also disclosed herein is a method for functionalizing surfaces via chemical modification. In one embodiment, the method comprises deposition of an oxophilic metal on an oxidized substrate. In one aspect of this method, a chemically patterned surface can be prepared. For example, in one embodiment, the oxidized substrate is patterned with resist. In this embodiment, deposition of the oxophilic metal results in a chemically patterned surface. Before or after coupling of the oxophilic metal to the oxidized substrate, the metal may be functionalized with a linker molecule, which in turn may be coupled to a nanoparticle. The nanoparticle may be formed before or after coupling to the linker, oxophilic metal and/or substrate. Typically, however, the nanoparticle is synthesized separately, and subsequently is functionalized with the linker and the nanoparticle-linker conjugate is then coupled to the oxophilic metal. However, these array components may be assembled in any order.

Examples of oxidized substrates include those formed via oxidation of coinage metals, such as copper, silver or gold. Another example of an oxidized substrate includes silicon oxide.

The oxophilic metal can be any metal with an affinity for the oxidized surface and capable of being functionalized with a linking group. Examples of typical oxophilic metals suitable for functionalizing surfaces as disclosed herein include, without limitation, titanium zirconium and hafnium.

In some embodiments, nanoparticles are coupled to the substrate or to the linker molecule by ligand exchange reactions. In such situations, a nanoparticle, prior to contacting the substrate or linker molecule, typically includes at least one, and more commonly, plural exchangeable ligands bonded thereto. Examples of exchangeable ligands suitable for forming metal nanoparticles may be selected from the group consisting of sulfur-bearing compounds, such as thiols, thioethers (i.e., sulfides), thioesters, disulfides, and sulfur-containing heterocycles; selenium bearing molecules, such as selenides; nitrogen-bearing compounds, such as 1°, 2° and perhaps 3° amines, aminooxides, pyridines, nitrites, and hydroxamic acids; phosphorus-bearing compounds, such as phosphines; and oxygen-bearing compounds, such as carboxylates, hydroxyl-bearing compounds, such as alcohols; and mixtures thereof.

The distance between nanoparticles affects the electronic properties of an array of nanoparticles. For example, electron tunneling decays exponentially with distance between nanoparticles. Generally, the scaffold and the nanoparticle ligands define the nanoparticle separation. The scaffold can define the maximum separation of one nanoparticle from a second, and the ligands can define the minimum possible separation of the nanoparticles. For useful tunneling between nanoparticles, the spacing between nanoparticles is provided by ligands comprising a chain typically having from about 2 to about 20 methylene units, with more typical embodiments having the spacing provided by ligands comprising a chain having from about 2 to about 10 methylene units, such that an inter-nanoparticle distance of from about 1 nm to about 30 nm, such as from about 2 nm to about 20 nm, and in certain embodiments from about 5 nm to about 15 nm is provided. Other ligands that yield closely packed nanoparticles, e.g. those that provide an inter-nanoparticle distance of from about 3 Å to about 30 Å, are suitable for making electronic devices.

Electronic devices based on the Coulomb blockade effect also are described that are designed to operate at or about room temperature. Such electronic devices include a first nanoparticle (e.g. a nanoparticle comprising a metal nanoparticle core having a diameter of between about 0.7 nm and about 5 nm) and a second such nanoparticle. In one embodiment, the nanoparticles are physically spaced apart from each other at a distance of less than about 5 nm by coupling the nanoparticles to a scaffold, such as a biomolecular scaffold, for example a protein or nucleic acid having a defined structure, so that the physical separation between the nanoparticles is maintained. In another embodiment, the nanoparticles are spaced apart from about 5 nm to about 200 nm, such as from about 15 to about 80 nm, but typically are spaced apart by from about 1 nm to about 25 nm.

Devices may be manufactured by taking advantage of the well-defined location of various chemical moieties on particular substrates in combination with chemoselective coupling techniques. Thus, different nanoparticle types having different electronic properties and bearing different functional groups can be placed at a particular predetermined location on a scaffold. Particular device features include conductors, inductors, transistors, and arrays of such features; such as to form logic gates and memory arrays.

Because of their unique architecture, electronic devices comprising the nanoparticles described herein exhibit a linear increase in the number of electrons passing between pairs of nanoparticles as the potential difference between the two nanoparticles is increased above a threshold value.

The foregoing and other objects, features, and advantages of the invention will become more apparent from the following detailed description, which proceeds with reference to the accompanying figures.

### BRIEF DESCRIPTION OF THE DRAWINGS

FIG. 1 is a representative TEM micrograph of a gold nanoparticle assembly on silicon dioxide.

FIG. 2a is an electron probe microanalyzer (EPMA) line scan over a 300 μm patterned square, wherein Au and Hf were only observed in functionalized areas.

FIG. 2b is a SEM backscatter images of a patterned square, wherein the brightness of the square is indicative of higher electron density in the patterned area, and the line across the square illustrates the path of a typical EPMA line scan.

FIG. 3 includes PM-IRRAS spectra for octadecylphosphonic acid monolayers formed directly on gold (dashed line) and on gold modified with a hafnium linker (solid line).

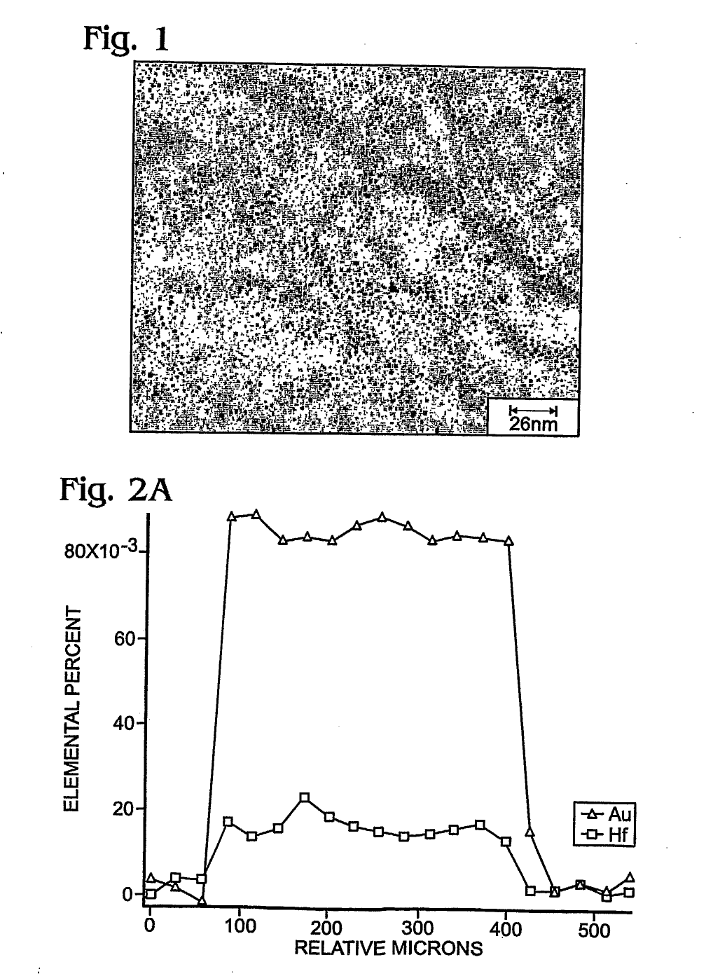

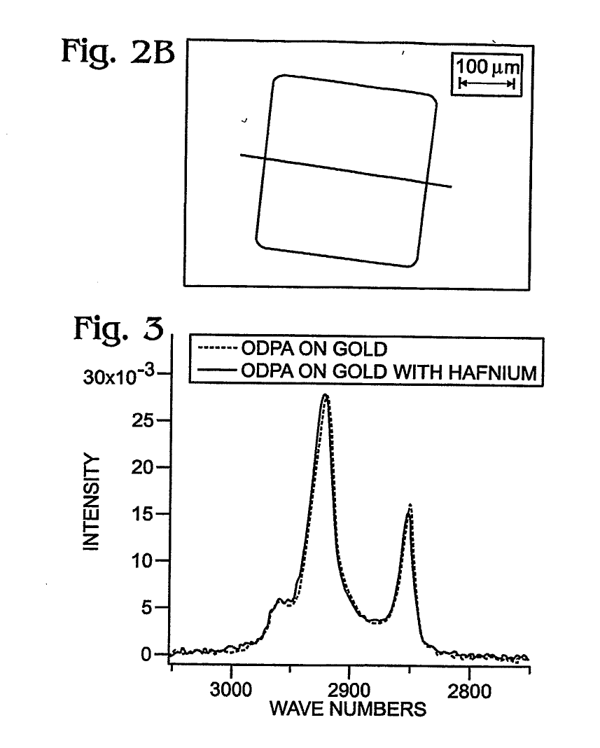

### DETAILED DESCRIPTION

### Abbreviations and Definitions

The following abbreviations and definitions are provided to facilitate the reader's understanding of the disclosed technology but not to define terms to have a scope narrower than would be understood by a person of ordinary skill in the art.

Certain abbreviations used in the specification include:

PL—polylysine

PLL—poly-L-lysine

AFM—atomic force microscopy

TEM—transmission electron microscopy

SEM—scanning electron microscopy

PMMA—polymethyl methacrylate

XPS—X-ray photoelectron spectroscopy

ODT—octadecylthiol

TOABr—tetraoctylammonium bromide

As used herein, the singular terms “a,” “an,” and “the” include plural referents unless context clearly indicates otherwise. Similarly, the word “or” is intended to include “and” unless the context clearly indicates otherwise. Also, as used herein, the term “comprises” means “includes.” Hence “comprising A or B” means including A, B, or A and B.

“Optional” or “optionally” means that the subsequently described event or circumstance can but need not occur, and that the description includes instances where said event or circumstance occurs and instances where it does not.

An overview of an embodiment of the process used to produce organized arrays comprising metal, alloy, semiconductor and/or magnetic nanoparticles includes (1) coupling molecular scaffolds to substrates, generally a metal, glass or semiconductor material having an oxidized surface, in predetermined patterns, (2) forming substantially monodisperse, relatively small (Coulomb blockade effects are dependent upon nanoparticle size, e.g., metal particles having a diameter of less than about 2 nm exhibit Coulomb blockade behavior at room temperature) ligand-stabilized metal, alloy, semiconductor and/or magnetic nanoparticles, (3) coupling the ligand-stabilized nanoparticles to the scaffolds to form organized arrays, (4) coupling electrical contacts to the organized arrays, and (5) using such constructs to form electronic, particularly nanoelectronic, devices. Alternatively, nanoparticles can be coupled to scaffolds prior to coupling the scaffolds to substrates.

Certain of the following passages therefore describe how to make and use devices based on metal nanoparticle arrays. Unless expressly stated otherwise, or the context indicates differently, it should be understood that any reference in this application to “metal nanoparticles” or “nanoparticles” typically refers to metal nanoparticles, alloy nanoparticles, semiconductor nanoparticles, magnetic nanoparticles, and combinations thereof.

Nanoparticles are so termed because the size of each such nanoparticle is on the order of about one nanometer. Typically, nanoparticles have a diameter of less than about one micron. In terms of diameters, “nanoparticle” is defined herein as having a diameter (d_{core}, not including the ligand sphere) of from about 0.7 nm to about 5 nm (7 Å to about 50 Å), for example, from about 0.7 nm to about 2.5 nm (7 Å to about 25 Å), and more typically from about 0.8 nm to about 2.0 nm (8 Å to about 20 Å).

It currently is believed that nanoparticles having diameters much larger than about five nanometers are less useful for forming electronic devices that operate on the Coulomb blockade principle at or about room temperature. Accordingly, in certain embodiments, the nanoparticle core, considered without any accompanying ligands, typically will have a diameter (d_{core}) of less than about 5 nm. More typically d_{core} of the nanoparticles described herein is less than about 2 nm. In one embodiment, the d_{core} is from about 0.7 to about 1.4 nm. Certain embodiments employ Au₁₁ nanoparticles having a diameter of about 0.8 nm.

In other embodiments, larger nanoparticles are used, for example, nanoparticles having a d_{core} of larger than about 5 nm are useful for certain applications, including optical applications, such as forming wave guides. In one embodiment such large nanoparticles have a d_{core} of from about 10 to about 170 nm, such as from about 15 to about 80 nm.

Particular embodiments used nanoparticles having a diameter including the ligand sphere of from about 0.8 nm to about 2 nm. Such nanoparticles included, without limitation those having diameters of 0.8±0.2 nm, 1.1±0.3 nm, 1.2±0.3 nm, 1.3±0.4 nm and 1.9±0.7 nm.

“Substantially monodisperse” with respect to present embodiments means particles having substantially the same size. The useful conducting properties of the arrayed nanoparticles diminish if the particle size distribution comprises greater than about a 30% polydispersity calculated at two standard deviations. Thus, a collection of substantially monodisperse nanoparticles should have less than about a 30% dispersion for the purposes of present embodiments. The Au₁₁ nanoparticles described herein are substantially completely monodisperse, meaning that they are monodisperse as judged by all analytical techniques employed to date. If the nanoparticles are metal nanoparticles, then the metal may be selected from the group consisting of Ag, Au, Pt, Pd, Co, Fe and mixtures thereof. The metal nanoparticle may have a d_{core} of from about 0.7 nm to about 5 nm. Particular working examples comprise gold nanoparticles having average diameters of about 1.4-1.5 nm, which traditionally have been referred to as Au₅₅ nanoparticles. Additional working examples employ Au₁₁ nanoparticles, which have a diameter of about 0.8 nm. Useful compositions for forming patterned arrays of metal, alloy, semiconductor and/or magnetic nanoparticles are provided below. Additional compositions useful in the present method are disclosed in U.S. Patent Application Publication No. 2003/0077625, published Apr. 24, 2003, and U.S. Pat. No. 6,730,537, which are incorporated herein by reference.

An “array” is an arrangement of plural such nanoparticles spaced suitably from one another for forming electronic components or devices. The spacing should be such as to allow for electron tunneling between nanoparticles of the array. Examples include lower order arrays, such as one-dimensional arrays, one example of which comprises plural nanoparticles arranged substantially linearly. Plural such arrays can be organized, for example, to form higher order arrays, such as a junction comprising two or more lower order arrays. A higher order array also may be formed by arranging nanoparticles in two or three dimensions, such as by coupling plural nanoparticles to two- or three-dimensional scaffolds, and by combining plural lower order arrays to form more complex patterns, particularly patterns useful for forming electronic devices. Features of embodiments of the present method include, both individually and in combination, the small physical size of the metal nanoparticles, the substantial monodispersity or monodispersity of the nanoparticles, the ligand exchange chemistry and/or the nature of the ligand shell produced by the ligand exchange chemistry. The small physical size of the metal nanoparticles provides a large Coulomb charging energy. The ligand-exchange chemistry allows tailoring of the ligand shell for a particular purpose and immobilize the nanoparticles on biomolecules. And, the ligand shell offers a uniform and chemically adjustable tunnel barrier between nanoparticle cores.

The following paragraphs describe particular embodiments and applications in greater detail.

### I. FORMING SUBSTANTIALLY MONODISPERSE LIGAND-STABILIZED NANOPARTICLES

One aspect of the present disclosure includes the recognition that substantially monodisperse, relatively small metal nanoparticles can be used to develop electronic devices that operate at or about room temperature based on the Coulomb blockade effect.

The term “nanoparticles” as used herein refers to more than one, and typically three or more, metal, alloy, semiconductor or magnetic atoms, typically coupled to one another, such as either covalently, ionically or both. Nanoparticles are intermediate in size between single atoms and colloidal materials. As discussed above, a goal is to provide electronic devices that operate at or about room temperature. This is possible if the nanoparticle size is made small enough to meet Coulomb blockade charging energy requirements at room temperature. While nanoparticle size itself is not dispositive of whether the nanoparticles are useful for forming devices operable at or about room temperature, nanoparticle size is nonetheless a factor.

Prior approaches typically have used polydisperse metal nanoparticles wherein the size of the metal nanoparticles is not substantially uniform. A completely monodisperse population is one in which the size of the metal nanoparticles is identical as can be determined by currently used characterization procedures. However, complete monodispersity is difficult, if not impossible, to achieve in most sizes of nanoparticles. Although complete monodispersity is not required to produce devices operating at or about room temperature based on the Coulomb blockade effect, as the dispersity of the nanoparticle population proceeds from absolute monodispersity towards polydispersity the likelihood that the device will operate reliably at room temperature, based on the Coulomb blockade effect, decreases. For example, Au₁₁ nanoparticles prepared as described herein are virtually completely monodisperse. However, 1.4-1.5 nm diameter gold nanoparticles are not as monodisperse as Au₁₁ particles, which have a diameter of about 0.8 nm. Moreover, as the radius of the metal nanoparticle decreases, the intrinsic capacitance gets smaller. As capacitance gets smaller, the charging energy of the nanoparticle gets larger. Coulomb blockade effects are observed when the charging energy exceeds the thermal energy at room temperature. Prior approaches have used nanoparticles that are generally larger than would be useful for forming devices that operate at room temperature based on the Coulomb blockade effect. In contrast, the present method forms metal nanoparticles having relatively small diameters.

With its ligand shell, the diameter of the ligand-stabilized metal nanoparticle can vary. The size of the ligand shell may influence the electron-tunneling rate between nanoparticles. Tunneling rate is exponentially related to the thickness of the ligand shell. As a result, the diameter of the ligand shell may be tailored for a particular purpose. It currently is believed that the diameters for ligand-stabilized nanoparticles useful for preparing electronic devices should be from about 0.8 nm to about 5 nm. The relatively large metal nanoparticles made previously do not provide a sufficiently large Coulomb charging energy to operate at room temperature. Instead, prior known materials generally only operate at temperatures of from about 50 mK to about 10 K.

“Bare” nanoparticles, i.e., those without ligand shells, also may be useful for preparing particular embodiments of electrical devices. For example, bare nanoparticles can be used to form electrical contacts.

Still another consideration is the distance between the edges of metal nanoparticle cores. It currently is believed that the maximum distance between the edges of nanoparticle cores for useful nanoparticles is about 5 nm (50 Å), and ideally is on the order of from about 1 to about 2 nm (10-20 Å).

In certain embodiments, the nanoparticle ligands are selected such that a nanoparticle density on the substrate is from about 200 to about 2000 nanoparticles per 100 nm×100 nm area, such as from about 400 to about 1600 nanoparticles per 10,000 nm² area. In certain embodiments the nanoparticle density is from about 500 to about 800 nanoparticles per 10,000 nm² area. Of course these densities are for a monolayer, a two-dimensional array of nanoparticles. Similar nanoparticle spacing also is present in, for example, one-dimensional arrays, such as lines formed using the nanoparticles.

Solely by way of example, metals used to form ligand-stabilized metal nanoparticles may be selected from the group consisting of silver (Ag), gold (Au), platinum (Pt), palladium (Pd), cobalt (Co), iron (Fe), and mixtures thereof. “Mixtures thereof” refers to having more than one type of metal nanoparticle coupled to a particular scaffold, different metal nanoparticles bonded to different scaffolds used to form a particular electronic device, or having different elements within a nanoparticle. Thus it is possible that metal alloy nanoparticles, e.g., gold/palladium nanoparticles, can be used to form nanoparticle arrays and electronic devices.

Gold is a particularly useful metal for forming ligand-stabilized monodisperse metal nanoparticles. This is because (1) embodiments of the present method of gold nanoparticle ligand exchange chemistry conveniently provides well-defined products, (2) Au₁₁ has a diameter of about 0.8 nm and Au₅₅ has a diameter of about 1.4 nm, making these particles particularly useful for forming organized metal arrays that exhibit the Coulomb blockade effect at or about room temperature, and (3) it is possible to prepare nearly monodisperse gold nanoparticles without lengthy purification requirements, such as lengthy crystallization processes.

Nanoparticles comprising semiconductor materials also may be useful for preparing electronic devices. Semiconductor materials that may be prepared as nanoparticles and stabilized with ligand spheres include, without limitation, cadmium selenide, zinc selenide, cadmium sulfide, cadmium telluride, cadmium-mercury-telluride, zinc telluride, gallium arsenide, indium arsenide and lead sulfide.

Magnetic particles also may be used to decorate scaffolds to provide structures having useful properties. An example, without limitation, of such magnetic particles is iron oxide (Fe₂O₃).

### II. LIGANDS

### A. Background

Once a suitable metal, alloy, semiconductor and/or magnetic material is selected for forming desired nanoparticles, ligands for bonding to the nanoparticles also must be selected. The assembly of nanoparticles into structures suitable for nanoelectronic applications, e.g., Coulomb blockade, involves molecular-scale organization of the nanoparticles without destroying the insulating ligand sphere between individual nanoparticles. The nanoparticles also should be coupled to the substrate in a sufficiently robust manner to allow fabrication of devices incorporating nanoparticle arrays. This may be accomplished in certain instances by ligand exchange reactions. The selection of ligands for forming an insulating ligand layer about the nanoparticle and for undergoing ligand exchange reactions therefore is a consideration. Criteria useful for selecting appropriate ligands include, but are not limited to, (1) the ligand's ability to interact with the substrate and/or oxophilic metal deposited thereon, such as through ligand-exchange, coulombic, intercalative, or covalent bond-forming interactions, (2) solubility characteristics conferred upon the ligand-metal nanoparticle complexes by the ligand, and (3) the formation of well ordered, metal-ligand complexes having structural features that promote room temperature Coulomb-blockade effects.

### B. Classes of Ligands

Ligands suitable for forming metal nanoparticles may be selected, without limitation, from the group consisting of sulfur-bearing compounds, such as thiols, thioethers, thioesters, disulfides, and sulfur-containing heterocycles; selenium bearing molecules, such as selenides; nitrogen-bearing compounds, such as 1°, 2° and perhaps 3° amines, aminooxides, pyridines, nitriles, and hydroxamic acids; phosphorus-bearing compounds, such as phosphines; and oxygen-bearing compounds, such as carboxylates, hydroxyl-bearing compounds, such as alcohols, and polyols; and mixtures thereof. Particularly effective ligands for metal nanoparticles may be selected from compounds bearing elements selected from the chalcogens. Of the chalcogens, sulfur is a particularly suitable ligand, and molecules comprising sulfhydryl moieties are particularly useful ligands for stabilizing metal nanoparticles. Additional guidance concerning the selection of ligands can be obtained from Michael Natan et al's Preparation and Characterization of Au Colloid Monolayers, Anal. Chem. 1995, 67, 735-743, which is incorporated herein by reference.

Sulfur-containing molecules (e.g., thiols, sulfides, thioesters, disulfides, sulfur-containing heterocycles, and mixtures thereof) comprise a particularly useful class of ligands. Thiols, for example, are a suitable type of sulfur-containing ligand for several reasons. Thiols have an affinity for gold, and gold, including gold particles, may be formed into electrodes or electrode patterns. Moreover, thiols are good ligands for stabilizing gold nanoparticles, and many sulfhydryl-based ligands are commercially available. The thiols form ligand-stabilized metal nanoparticles having a formula Mₓ(SR)ₙ wherein M is a metal, R is an aliphatic group, typically an optionally substituted chain (such as an alkyl chain) or aromatic group, x is a number of metal atoms that provide metal nanoparticles having the characteristics described above, and n is the number of thiol ligands attached to the ligand-stabilized metal nanoparticles.

For incorporation into arrays, at least one nanoparticle ligand constitutes a linker molecule. A linker molecule is adapted to bind to the substrate and/or oxophilic metal deposited thereon, thereby linking the nanoparticle to the substrate. Linker functionalized nanoparticles include a wide variety of ligand-stabilized nanoparticles of the general formulas CORE-L-(S-X)ₙ, wherein L is the linker and X is a functional group or chemical moiety that serves to couple the nanoparticle to a the substrate, and n is at least one.

For example, X may include without limitation phosphonic acid groups, carboxylic acid groups, sulfonic acid groups, peptide groups, amine groups, and ammonium groups. Other functional groups that may be part of X include aldehyde groups and amide groups. In one embodiment, linker functionalized nanoparticles are prepared from phosphine-stabilized nanoparticles of the formula CORE-(PR₃)ₙ, where the R groups are independently selected from the group consisting of aromatic, such as phenyl and aliphatic groups, such as alkyl, typically such alkyl groups have 20 or fewer carbons, for example, cyclohexyl, t-butyl or octyl, and n is at least one.

In one embodiment the linker molecule is bifunctional, having one functional group adapted to bind to a nanoparticle and a second functional group adapted to bind to the oxophilic metal. The first and second functional groups may be the same or different. One example of such bifunctional linker molecules have the formula

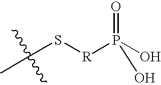

wherein R comprises an aliphatic group. In certain embodiments, R includes a lower alkyl group, and/or an aryl group, such as a phenyl or biphenyl moiety. In particular embodiments, R represents an alkylene group, optionally interrupted with one or more heteroatoms, such as oxygen or nitrogen. Examples of such alkylene groups interrupted with oxygen include polyethylene glycol (PEG) and/or polypropylene glycol (PPG) chains. As used herein, PEG and PPG refer to oligomeric groups having as few as two glycol subunits. Exemplary R groups include, without limitation, —CH₂CH₂—, —CH₂CH₂OCH₂CH₂— and —CH₂CH₂OCH₂CH₂OCH₂CH₂—.

### C. General Method for Producing Ligand-Stabilized Metal Nanoparticles

The general approach to making ligand-stabilized, metal nanoparticles first comprises forming substantially or completely monodisperse metal nanoparticles having displaceable ligands. This can be accomplished by directly forming such metal nanoparticles having the appropriate ligands attached thereto, but is more likely accomplished by first forming such ligand-stabilized, metal nanoparticles, which act as precursors for subsequent ligand-exchange reactions with ligands that are more useful for coupling nanoparticles to substrates.

One example, without limitation, of a substantially monodisperse gold nanoparticle that has been produced, and which is useful for subsequent ligand-exchange reactions with the ligands listed above, is the 1.4 nm phosphine-stabilized gold particle described by Schmid, Inorg. Syn. 1990, 27, 214-218, which is incorporated herein by reference. Schmid's synthesis involves the reduction of AuCl[PPh₃]. Example 1 below also discusses the synthesis of 1.4 nm phosphine-stabilized gold particles. One advantage of this synthesis is the relatively small size distribution of nanoparticles produced by the method, e.g., 1.4±0.4 nm. The formula of such 1.4 nm gold nanoparticles has been shown to be Au₁₀₁(PPh₃)₂₁Cl₃ (See, Weare, W. W.; Reed, S. M.; Warner, M. G.; Hutchison, J. E. J. Am. Chem. Soc. 2000, 122, 12890-12891, which is incorporated herein by reference).

Once ligand-stabilized, substantially monodisperse metal nanoparticles are obtained, such nanoparticles can be used for subsequent ligand-exchange reactions, as long as the ligand-exchange reaction is readily facile and produces monodisperse metal nanoparticles. Previously, it was not appreciated that the ligand exchange chemistry phosphine-stabilized gold nanoparticles could yield nearly monodisperse 1.4 nm nanoparticles stabilized by ligands other than phosphines. In fact, some literature reports indicated that it was difficult, if not impossible, to form linked metal nanoparticles by ligand-exchange reactions. See, for example, Andres et al's Self-Assembly of a Two-Dimensional Superlattice of Molecularly Linked Metal Nanoparticles, Science, 1996, 273, 1690-1693.

To perform ligand-exchange reactions, a reaction mixture is formed comprising the metal nanoparticle having exchangeable ligands attached thereto and the ligands to be attached to the metal nanoparticle, such as thiols. A precipitate generally forms upon solvent removal, and this precipitate is then isolated by conventional techniques. See Example 3 for further details concerning the synthesis of ligand-stabilized 1.4-1.5 nm gold nanoparticles.

An example of a monodisperse gold nanoparticle is Au₁₁. Phosphine-stabilized undecagold particles are disclosed by Bartlett et al.'s Synthesis of Water-Soluble Undecagold Cluster Compounds of Potential Importance in Electron Microscopic and Other Studies of Biological Systems, J. Am. Chem. Soc. 1978, 100, 5085-5089, which is incorporated herein by reference. Au₁₁(PPh₃)₈Cl₃ may be prepared as described in Example 2. However, application of the present method for ligand exchange chemistry to smaller particles, e.g. phosphine-stabilized undecagold complexes was not a straightforward extension of the chemistry developed for the larger nanoparticles. The ligand exchange conditions used for the 1.4 nm gold particles fail when applied to Au₁₁ particles. However, conditions under which Au₁₁(PPh₃)₈Cl₃ undergoes controlled ligand exchange with a variety of thiols to produce both organic- and water-soluble nanoparticles are disclosed herein. Examples 4-6 demonstrate ligand exchange reactions of Au₁₁(PPh₃)₈Cl₃ with structurally diverse thiols. Au₁₁(PPh₃)₈Cl₃ is a particularly useful precursor for forming thiol-stabilized, Au₁₁ particles because it is a molecular species with a defined chemical composition and is thus monodisperse.

### III. PRODUCTION AND USE OF GOLD NANOPARTICLES

Disclosed herein are embodiments of a method for producing gold nanoparticles that are substantially simpler and safer than the traditional route, which employs diborane gas (see Example 1, below). TEM, XPS and ligand (thiol) exchange reactions respectively reveal that the size, composition and reactivity of nanoparticles synthesized using this new method are comparable to those produced by the traditional route. Additionally, this simple route can produce large quantities of gold nanoparticles capped by tricyclohexylphosphine or trioctylphosphine, producing a novel class of trialkylphosphine-stabilized nanoparticles.

First described by Schmid in 1981, phosphine-stabilized gold nanoparticles, commonly referred to as “Au 55,” paved the way for investigating the properties of metal nanoparticles. These nanoparticles have a diameter of about 1.4 nm, thus nanoparticles prepared by the Schmid protocol also are referred to herein as 1.4 nm nanoparticles. The small size and low dispersity of triphenylphosphine-passivated gold nanoparticles continues to make them important tools in nanoelectronics, biological tagging, and structural studies. Recently the ability to exchange thiol ligands onto triphenylphosphine-passivated nanoparticles was demonstrated, which enabled the coupling of small size and low dispersity with the stability of thiol-passivated gold. This facilitates applications that require both high stability and small core size, such as room temperature, Coulomb-blockade-based nanoelectronics. One embodiment of this method provides a convenient gram-scale synthesis of 1.4 nm triphenylphosphine-stabilized nanoparticles that are comparable in both size and reactivity to the traditional 1.4 nm nanoparticles prepared by the Schmid protocol. This route utilizes commercially available reagents and replaces a hazardous reducing agent. The generality of this synthetic method has been explored through the synthesis of previously unknown aliphatic, phosphine-stabilized gold nanoparticles, particularly trialkylphosphine-stabilized nanoparticles.

A working embodiment of the synthesis is illustrated by Scheme 1.

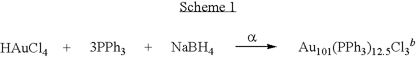

With reference to Scheme 1, “a” refers to reaction conditions, including an organic-aqueous solvent system (e.g., toluene:water biphasic solvent system), a phase transfer catalyst, such as tetraoctylammonium bromide (see below), and a reaction time suitable to provide desired products (e.g., about 5 hours). Formula “b” is the empirical formula of the resulting product, which is based upon size and atomic composition measurements.

Phosphine-stabilized gold nanoparticles produced as described herein can be used in any applications in which traditionally synthesized gold nanoparticles are used.

In certain embodiments, gold nanoparticles can be used in combination with other labels, such as fluorescent or luminescent labels, which provide different methods of detection, or other specific binding molecules, such as a member of the biotin/(strept)avidin specific binding family (e.g., as described in Hacker et al. Cell Vision 1997, 4, 54-65.)

### IV. EXAMPLES

The following examples are provided to illustrate certain particular embodiments of the disclosure. It should be understood that additional embodiments not limited to these particular features described are consistent with the following examples.

### General Methods and Materials

Hafnium dichloride oxide octahydrate (Alfa Aesar; 99.998%), hafnium (IV) chloride (STREM; 99.9+%), n-octadecylphosphonic acid [CH₃(CH₂)₁₇P(O)(OH)₂] (Alfa Aesar), allyl mercaptan (Avocado Research Chemicals, Ltd.; 70%), zirconium dichloride oxide octahydrate (Alfa Aesar; 99.9%), Shipley 1818 Photoresist (Shipley Company, Marlborough, Mass.), Microposit 351 Developer (Shipley Company), and F-4 Photographic Fixer (Microchrome Technology, Inc., Reno, Nev.) were used as received. 2-Mercaptoethylphosphonic acid [HS(CH₂)₂P(O)(OH)₂] was synthesized as described in Example 11. Methyl alcohol (J. T. Baker; 100.0%) was distilled over magnesium. Deionized water (18.2 MΩ-cm) was purified with a Barnstead Nanopure Diamond system. Absolute ethyl alcohol (Aaper Alcohol and Chemical Company) was sparged with nitrogen for approximately 20 minutes prior to use.

### Example 1

This example describes the synthesis of 1.4 nm phosphine-stabilized gold particles. AuCl(PPh₃) was reduced in benzene using diborane (B₂H₆), which was produced in situ by the reaction of sodium borohydride (NaBH₄) and borontrifluoride etherate [BF₃.O(C₂H₅)]. Au₅₅(PPh₃)₁₂C₁₆ was purified by dissolution in methylene chloride followed by filtration through Celite. Pentane was then added to the solution to precipitate a black solid. The mixture was filtered and the solid was dried under reduced pressure to provide 1.4 nm phosphine-stabilized gold particles in approximately 30% yield.

### Example 2

This example describes the synthesis of Au₁₁(PPh₃)₈Cl₃, a triphenylphosphine-stabilized Au₁₁ nanoparticle. NaBH₄ (76 mg, 2.02 mmol) was slowly added to a mixture of AuCl(PPh₃) (1.00 g, 2.02 mmol) in absolute EtOH (55 mL) over 15 minutes. After stirring at room temperature for 2 hours, the mixture was poured into hexanes (1 L) and allowed to precipitate over approximately 20 hours. The resulting brown solid was collected and washed with hexanes (4×15 mL), CH₂Cl₂/hexanes (1:1 v/v 4×15 mL) and CH₂Cl₂/hexanes (3:1, 10 mL). The remaining solid was dissolved in CH₂Cl₂ (15 mL) and filtered a second time to remove a colorless, insoluble powder. Crystallization from CH₂Cl₂/hexanes gave Au₁₁(PPh₃)_{g}Cl₃ (140 mg, 18% yield) as deep red plates. The structure was confirmed by melting point, elemental analysis, X-ray photoelectron spectroscopy and ¹H NMR.

### Example 3

This example describes the synthesis of 1.4 nm thiol-stabilized gold particles. Dichloromethane (˜10 mL), 1.4 nm phosphine-stabilized gold particles (20.9 mg) and octadecylthiol (23.0 mg) were combined in a 25 mL round bottom. A black solution was produced, and this solution was stirred under nitrogen at room temperature for 36 hours. The solvent was removed under reduced pressure and acetone was added to suspend a black powder. The solid was isolated by vacuum filtration and washed with acetone (10×5 mL). After the final wash, the solid was redissolved in hot benzene. The benzene was removed under reduced pressure with gentle heating to yield a dark brown solid.

The solid material was then subjected to UV-VIS (CH₂Cl₂, 230-800 nm), ¹H NMR, ¹³C NMR, X-ray photoelectron spectroscopy (MS) and atomic force spectroscopy.

In the X-ray photoelectron spectroscopy (XPS) measurement, molecules are irradiated with high-energy photons of fixed energy. When the energy of the photons is greater than the ionization potential of an electron, the compound may eject the electron, and the kinetic energy of the electron is equal to the difference between the energy of the photons and the ionization potential. The photoelectron spectrum has sharp peaks at energies usually associated with ionization of electrons from particular orbitals. X-ray radiation generally is used to eject core electrons from materials being analyzed. Clifford E. Dykstra, Quantum Chemistry & Molecular Spectroscopy, pp. 296-295 (Prentice Hall, 1992).

Quantification of XPS spectra gave a gold-to-sulfur ratio of about 2.3:1.0 and shows a complete absence of phosphorus and chlorine. As is the case of the phosphine-stabilized nanoparticles, a broad doublet is observed for the Au 4f level. The binding energy of the Au 4f 7/2 level is about 84.0-84.2 eV versus that of adventitious carbon, 284.8 eV. This indicates absence of Au(I) and is similar to binding energies obtained for nanoparticles such as Au₅₅(PPh₃)₁₂Cl₆. The binding energy of the S 2p 3/2 peak ranges from 162.4 to 162.6 eV for the series of nanoparticles. These values are shifted to lower energy than those found for free thiols (163.3-163.9 eV) and are close to the values reported for thiolates bound to bulk gold (162.0-162.4 eV). “H and”¹³C NMR unambiguously rules out the possibility that unattached thiols may be present in the sample.

Thermal gravimetric analysis confirmed the Au:S ratio obtained from XPS. On heating to 600° C., ODT-stabilized nanoparticles display a 40% mass loss, corresponding to 26 ODT ligands on an assumed 55-atom gold nanoparticle. This ratio alludes to the retention of a small nanoparticle size. A sample of the larger hexadecanethiol-stabilized gold nanoparticle has been shown to give a 33.5% mass loss, corresponding to from about 95 to about 126 ligands per nanoparticle (diameter=2.4 nm).

Optical spectra of gold colloids and nanoparticles exhibit a size-dependent, surface plasmon resonance band at about 520 nm. In absorption spectra of ligand-exchanged nanoparticles produced as stated in this example, the interband transition typically observed for small nanoparticles, including Au₅₅(PPh₃)₁₂Cl₆, was observed. Little or no plasmon resonance was observed, consistent with a nanoparticle size of about 1.7 nm or less. For the ODT-passivated nanoparticle, no plasmon resonance was observed.

Quantitative size information can be obtained using transmission electron microscopy (TEM). The core size obtained from TEM images of the ODT-stabilized nanoparticle was found to be 1.7±0.5 nm and agrees with the size obtained from atomic force microscope images.

Atomic force microscopy (AFM) also was performed on the Au₅₅(SC₁₈H₃₇)₂₆ produced according to this example. The analysis produced a topographical representation of the metal complex. AFM probes the surface of a sample with a sharp tip located at the free end of a cantilever. Forces between the tip and the sample surface cause the cantilever to bend or deflect. The measured cantilever deflections allow a computer to generate a map of surface topography. Rebecca Howland et al. A Practical Guide to Scanning Probe Microscopy, p. 5, (Park Scientific Instruments, 1993). The AFM data for particles produced according to this example showed heights of 1.5 nm for single nanoparticles and aggregates subjected to high force. This corresponds to the size of the gold core nanoparticles. This helped establish that the gold nanoparticles of this example were close to the correct size for forming useful devices. In a manner similar to that described above for Example 2, thiol stabilized structures also have been made using 1-propanethiol.

### Example 4

This example describes the preparation of an organic-soluble, octadecane thiol-stabilized Au₁₁ particles from monodisperse Au₁₁(PPh₃)₈Cl₃ via ligand exchange. A mixture of Au₁₁(PPh₃)₈Cl₃, prepared according to the procedure of Example 2, (10 mg, 2.3 μmol) and octadecanethiol (13 mg, 45 μmol) dissolved in CHCl₃ (30 mL) was stirred for 24 hours at 55° C. Volatiles were removed and the crude solid product was dissolved in i-PrOH and filtered to remove insoluble Au(I) salts. The filtrate was purified via gel filtration over Sephadex LH-20 using i-PrOH as the eluent. The purified octadecanethiol-stabilized particles yielded satisfactory ¹H NMR and ¹³C NMR. Well-defined optical absorptions in the visible spectrum are distinguishable from the spectra obtained for the larger 1.5 nm core particles by inspection.

### Example 5

This example describes the preparation of a water-soluble, (N,N-dimethylamino) ethanethiol-stabilized Au₁₁ particle. A mixture of (N,N-dimethylamino) ethanethiol hydrochloride (12 mg, 85 μmol) in degassed H₂O (30 mL) and Au₁₁(PPh₃)₈Cl₃ (20 mg, 4.6 μmol) in degassed CHCl₃ (30 mL) was stirred vigorously for 9 hours at 55° C. (until all colored material was transferred into the aqueous layer). The layers were separated and the aqueous layer washed with CH₂Cl₂ (3×15 mL). Volatiles were removed and the crude solid product was dissolved in EtOH (3 mL) and precipitated with hexanes. The precipitate was collected on a frit and washed with hexanes (30 mL) and CHCl₃ (30 mL). The washed material yielded analytical data (¹H NMR, TEM, XPS) consistent with (N,N-dimethylamino) ethanethiol-stabilized Au₁₁ nanoparticles of an average core size of 0.9±0.2 nm.

### Example 6

This example concerns the preparation of a water-soluble, sodium 2-mercaptoethanesulfonate-stabilized Au₁₁ particle. A mixture of Au₁₁(PPh₃)₈Cl₃ (29 mg, 6.7 μmol) in CHCl₃ (20 mL) and sodium-2-mercaptoethanesulfonate (24 mg, 146 μmol) in H₂O was stirred vigorously for 1.5 hours at 55° C., until all colored material was transferred into the aqueous layer. The layers were separated and the aqueous layer was extracted with CH₂Cl₂ (3×20 mL). After removal of the water, the crude product was suspended in methanol, transferred to a frit and washed with methanol (3×20 mL). The resulting material (25 mg, 5.8 μmol) and additional sodium 2-mercaptoethanesulfonate (5 mg, 30 μmol) in H₂O/THF (1:1, 40 mL) was stirred vigorously for 6 h at 50° C. The mixture was washed with CHCl₃ (3×20 mL) to remove THF. After the water was removed in vacuo the crude material was suspended in methanol (30 mL), transferred to a frit and washed with methanol (3×20 mL) to remove excess ligand. ¹H NMR, XPS analysis, and TEM micrographs confirmed the desired structure.

### Example 7

This example describes the synthesis of 4-mercaptobiphenyl-stabilized 1.4 nm gold nanoparticles. Dichloromethane (˜10 mL), 1.4 nm triphenylphosphine-stabilized gold nanoparticles (prepared according to the procedure of Example 1) (25.2 mg) and 4-mercaptobiphenyl (9.60 mg) were combined in a 25 mL round bottom. The resulting black solution was stirred under nitrogen at room temperature for 36 hours. The solvent was removed under reduced pressure and replaced with acetone. This resulted in the formation of a black powder suspension. The solid was isolated by vacuum filtration and washed with acetone (6×5 mL). The solvent was then removed under reduced pressure to yield 16.8 mg of a dark brown solid.

The solid material was subjected to UV-Vis (CH₂Cl₂, 230-800 nm), ¹H NMR, ¹³C NMR, X-ray photoelectron spectroscopy (XPS) and atomic force spectroscopy as in Example 2. This data confirmed the structure and purity of the metal complex, and further showed complete ligand exchange. For example, quantification of the XPS data for material prepared according to this example showed that Au 4f comprised about 71.02% and S 2p constituted about 28.98%, which suggests a formula of Au₅₅(S-biphenyl)₂₅.

AFM analysis showed isolated metal nanoparticles measuring about 2.5 nm across, which correlates to the expected size of the gold core with a slightly extended sphere.

Thiol-stabilized nanoparticles produced as described above display remarkable stability relative to 1.4 nm phosphine-stabilized gold nanoparticles, which decomposes in solution at room temperature to give bulk gold and AuCl[PPh₃]. No decomposition for the thiol-stabilized nanoparticles was observed, despite the fact that some samples were deliberately stored in solution for weeks. In other tests, the mercaptobiphenyl and octadecylthiol-stabilized nanoparticles (in the absence of free thiol) were heated to 75° C. for periods of more than 9 hours in dilute 1,2-dichloroethane solution with no resultant degradation. Under identical conditions, 1.4 nm phosphine-stabilized gold nanoparticles decompose to Au(O) and AuCl[PPh₃] within 2 hours.

### Example 8

This example describes the electron transfer properties of organometallic structures formed by electron-beam irradiation of 1.4 nm phosphine-stabilized gold nanoparticles. This compound was produced as stated above in Example 1. A solution of the gold nanoparticle was made by dissolving 22 mg of the solid in 0.25 mL of CH₂Cl₂ and 0.25 mL of 1,2-dichloroethane. A supernatant solution was spin coated onto a Si₃N₄ coated Si wafer at 1,500 rpm for 25 seconds immediately after preparation. The film was patterned by exposure to a 40 kV electron beam at a line dosage of 100 nC/cm. The areas of the film exposed to the electron beam adhered to the surface and a CH₂Cl₂ rinse removed the excess film. This procedure produced well-defined structures. These structures appeared to be smooth and continuous under SEM inspection. Attempts were made to pattern the material using 254 nm UV lithography, but it was found to be insensitive to this wavelength. The defined structures had dimensions as small as 0.1 μm and AFM inspection measured the film thickness to be 50 nm.

The organometallic samples were spin-coated with PMMA that was electron-beam exposed and developed to define contact regions. Contacts were fabricated using thermal evaporation of 100 nm of gold and conventional liftoff procedures.

DC current-voltage (I-V) measurements of several samples were taken. A shielded chamber, submerged in an oil bath, contained the sample mounted on a clean teflon stage. Rigid triaxial connections were used to connect the sample to a constant DC voltage source and electrometer. The oil bath temperature was controlled from 195 to 350K. Thermal equilibrium was achieved with a 10 Torr partial pressure of He in the chamber. Before electrical measurements the chamber was evacuated to a pressure ˜10⁻⁵ Torr. The data showed little temperature drift over a typical four hour measurement sweep. The intrinsic leakage current of the system was measured using a control sample having the same substrate and contact pad arrangement as the actual samples, but did not have the organometallic between the pads. At room temperature, the leakage current was almost linearly dependent on bias over the range −100 to 100V, and had a maximum value # 100 fA. While the ultimate resolution of the current measurement was 10 fA, the leakage current set the minimum resolved conductance ˜10⁻¹⁵Ω⁻¹. Constant amplitude RF signals with frequencies, f, from 0.1 to 5 MHz, were applied to the samples through a dipole antenna at 195K. No attempt was made to optimize the coupling between the RF signal and the sample.

For one sample, as the temperature was reduced, the low voltage portion of the curve flattened out and the current became indistinguishable from the leakage current. Above an applied voltage magnitude of 6.7±0.6 V, the current increased abruptly. This establishes that substantially monodisperse gold nanoparticles can produce devices that operate on the basis of the Coulomb blockage effect.

Application of the RF signal introduced steps in the I-V characteristic, establishing that an applied external varying signal (the frequency of which is provided by the X axis) actually controls the rate at which electrons move through the metal nanoparticles. The current at which these steps occurred was found to be proportional to the applied signal frequency. A least squares analysis of the linear current-frequency relationship for the highest current step shown gives a slope of 1.59±0.04×10⁻¹⁹C.

The introduction of plateaus in the patterned sample I-V characteristics is similar to the RF response reported in other Coulomb blockade systems. This effect has been attributed to phase locking of single-electron tunneling events by the external RF signal. When the nth harmonic of the applied frequency corresponds to the mth harmonic of the frequency of tunneling in the system, mile, the current becomes locked to a value I=(n/m)ef. The results obtained suggest that correlated tunneling is present in the samples.

The patterned samples had stable I-V characteristics with time and temperature. Furthermore, as the temperature was raised above about 250K the I-V characteristics developed almost linear behavior up to V_{T}. The conductance below V_{T} was activated, with activation energies E_{A} in the range of from about 30 to about 70 meV. The charging energy can be estimated from the activation energy. Assuming current suppression requires E_{c}≧10 kT, the sample with the largest activation energy should develop a Coulomb gap below ˜300 K. This value is within a factor of 2 of the measured temperature at which clear blockade behavior occurs in the patterned samples. Given the accuracy to which E_{c} is known, the temperature dependence of the conductance within the Coulomb gap is consistent with the observation of blockade behavior. Using this value of E_{c}, the effective capacitance of a metal core in the patterned array is 3×10⁻¹⁹F<C<7×10⁻¹⁹F. These values are close, but larger than the classical geometric capacitance of an isolated 1.4 nm gold nanoparticle, where C=4π∈∈₀r˜2×10⁻¹⁹F, and where the dielectric constant, ∈, of the surrounding ligand shell is expected to be ˜3. The agreement between the two estimates indicates that the current suppression in the metal nanoparticle arrays is due to charging of individual 1.4 nm gold nanoparticles nanoparticles.

The non-linear I-V characteristic is similar to that of either a forward biased diode or one-/two-dimensional arrays of ultra small metal islands or tunnel junctions. However, the dependence of the I-V characteristic on the applied RF signal is not consistent with straightforward diode behavior. Therefore, the data has been analyzed in the context of an array of ultra small metal islands.

Several reports have discussed the transport in ordered arrays of tunnel junctions that have tunneling resistances greater than the quantum resistance h/e² and a charging energy significantly above the thermal energy. In this case Coulomb blockade effects introduce a threshold voltage below which current through the array is suppressed. As the applied voltage is increased well beyond threshold, the current-voltage characteristic approaches a linear asymptote with a slope related to the tunnel resistance. With the same temperature and tunnel resistance constraints, Middleton and Wingreen have discussed one- and two-dimensional arrays of maximally disordered normal metal islands where disorder is introduced as random offset charges on each dot. These authors predict current suppression below a threshold voltage and high bias current I˜(V/V_{T}−1)^{γ}. Here, the threshold voltage V_{T} scales with the number of junctions N along the current direction. Analytically γ=1 for one-dimensional systems and 5/3 for infinite two-dimensional systems. Numerical simulations of a finite two-dimensional array gave γ=2.0±0.2.

While no effort was made to order samples, data were analyzed using both the ordered and the disordered models. The only consistent analysis was found to be given by the disordered model. In particular, the high bias data did not have the linear asymptote predicted for an ordered system, but did scale as expected for a disordered system. A two-dimensional array was produced, such that charge propagates through the sample tested along plural parallel paths. Such an arrangement is useful for developing memory storage devices. The exponent γ˜1.6 is closest to the analytical prediction for an infinite, disordered two-dimensional array. From the analysis the magnitude of V_{T}˜6±1 V agrees with that estimated directly from the I-V data.

The introduction of steps in the I-V characteristics by a RF field is similar to the RF response reported in other systems. This effect has been attributed to phase locking of single-electron tunneling events by the external RF signal. If the applied frequency corresponds to a rational fraction multiple of the frequency of tunneling in the system, I/e, then the current is locked to a value I=(n/m)ef, where n and m are integers. Therefore, the linear relationships between f and I suggest that correlated tunneling is present in the samples. The lowest slope observed is best described with n/m=1/5. For frequencies up to 3 MHz, the current resolution is insufficient to distinguish between the 1/5 and 1/4 harmonics. However, at higher frequencies where it should have been possible to distinguish between 1/5 and 1/4, the 1/4 step was not observed.

At temperatures above about 250K, the I-V characteristic was almost linear up to V_{T}. In this regime the conductance was activated, with activation energies E_{A} in the range 30 to 70 meV for the samples studied. Similar activated behavior has been reported for tunnel junction systems. It was argued that for an infinite 2D array the charging energy for one island E_{C}≈4E_{A}. Applying this argument to the present system, and assuming current suppression requires E_{C}≧10 kT, the sample with the largest activation energy should develop a Coulomb gap below about 300 K. This estimate is within a factor of two of the measured temperature at which clear blockage behavior is seen. Thus, the temperature dependence of the observed current within the Coulomb gap is consistent with the observation of blockade behavior. From the threshold voltage, V_{T}=αNe/C, and this estimate of E_{C}, αN is approximately 10.

The energy E_{C} also can be estimated if the capacitance of an island is known. The capacitance of an isolated 1.4 nm gold nanoparticles nanoparticle is C=4π∈∈ₒτ, where τ is the radius of the nanoparticle and ∈ is the dielectric constant of the surrounding medium. The radius of an 1.4 nm gold nanoparticles nanoparticle is 0.7 nm and the ligand shell is expected to have ∈≈3, which C≈2×10⁻¹⁹F. The Coulomb charging energy, E_{C}=e²/2C≈340 meV, is within twenty percent of the maximum value of 4E_{A} found from the activation data. This result suggests that the current suppression is due to charging of individual 1.4 nm gold nanoparticles.

Given the constraint that steps in the I-V characteristics are only found when f<0.1/(R_{T}C), the fact that steps are seen up to f=5 MHz gives the upper limit R_{T}<1×10¹¹Ω. The differential resistance obtained from the I-V characteristic well above threshold is anticipated to be R_{diff}≈(N/M)R_{T}, where M is the number of parallel channels. This estimate yields N/M≧30. From the sample dimensions and the size of an individual nanoparticle, a close packed array would have N/M˜5. This disparity between the expected and experimentally derived values of the N/M suggests that the full width of the sample is not involved in transport. One explanation for the discrepancy in N/M may be that many of the gold cores coalesce during sample fabrication so that transport is dominated by individual nanoparticles between larger regions of gold.

### Example 9

This example describes a method for making phosphine-stabilized gold nanoparticles, particularly 1.4 nm (±0.5 nm) phosphine-stabilized gold nanoparticles. Traditional methods for making such molecules are known, and are, for instance, described by G. Schmid (Inorg. Syn. 1990, 27, 214-218) and in Example 1.

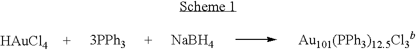

Scheme 1 (above) illustrates a convenient one-pot, biphasic reaction in which the nanoparticles can be synthesized and purified in less than a day from commercially available materials. Hydrogen tetrachloroaurate trihydrate (1.11 g, 3.27 mmol) and tetraoctyl-ammonium bromide (1.8 g, 3.3 mmol) were dissolved in a nitrogen-sparged water/toluene mixture (100 mL each). Triphenylphosphine (2.88 g, 11.0 mmol) was added, the solution stirred for five minutes until the gold color disappeared, and aqueous sodium borohydride (2.0 g, 41.0 mmol, dissolved in 5 mL water immediately prior to use) was rapidly added resulting in a dark purple color (this addition results in vigorous bubbling and should be performed cautiously). The mixture was stirred for three hours under nitrogen, the toluene layer was washed with water (5×100 mL) to remove the tetraoctylammonium bromide and borate salts and the solvent removed in vacuo to yield 1.3 g of crude product.

To effect further purification, the resulting solid was suspended in hexanes, filtered on a glass frit, and washed with hexanes (300 mL) to remove excess triphenylphosphine. Washing with a 50:50 mixture of methanol and water (300 mL) removed triphenylphosphine oxide. Each of these washes was monitored by TLC and the identity of the collected material was confirmed by ¹H and ³¹P NMR. Pure samples were obtained by precipitation from chloroform by the slow addition of pentane (to remove gold salts, as monitored by UV-Vis and NMR). After purification, this procedure yielded 644 mg of purified nanoparticle product from 1.35 g of hydrogen tetrachloroaurate (yield >90%). In contrast, the traditional synthesis yields about 300 mg of purified nanoparticle product per 2 g hydrogen tetrachloroaurate (29% yield).

For comparison of these nanoparticles to the products of the traditional synthesis the newly synthesized nanoparticles were analyzed to determine size, atomic composition, and reactivity as described below. The small size of the nanoparticles, which allows for examination of Coulomb blockade phenomena at room temperature, is a consideration for evaluating the effectiveness of the synthesis.

Direct evidence of nanoparticle size and dispersity is provided by transmission electron microscopy (TEM). TEM was performed on a Philips CM-12 microscope operating at a 100 kV accelerating voltage. Samples were prepared by drop casting dilute methylene chloride solutions onto 400-mesh nickel grids coated with carbon. Images were recorded as photographic negatives, scanned, and processed using NIH image software. A total of 1628 particles were examined from two separate synthetic runs, for the triphenylphosphine nanoparticles. Background noise and agglomerated nanoparticles were removed from the measurements by removing core sizes of <0.5 nm and >3 nm from the analysis. A representative TEM showed nearly monodisperse triphenylphosphine nanoparticles with a size of 1.4 nm±0.5 nm.

UV/Vis spectroscopy, a technique that is representative of the bulk material, was used to confirm TEM size determinations. UV-visible spectroscopy was performed on a Hewlett-Packard HP 8453 diode array instrument with a fixed slit width of 1 nm using 1 cm quartz cuvettes. The absence of a significant surface plasmon resonance at 520 nm indicates gold nanoparticles that are <2 nm diameter. UV/Vis spectra of newly synthesized nanoparticles are dominated by an interband transition, with no significant plasmon resonance at 520 nm. This indicates that there is no substantial population of nanoparticles greater than 2 nm in size.

Atomic composition of the nanoparticles was determined using the complementary techniques of x-ray photoelectron spectroscopy (XPS) and thermogravimetric analysis (TGA) allowing further comparison to traditionally prepared nanoparticles. TGA was performed under a nitrogen flow with a scan rate of 5° C. per minute. XPS was performed on a Kratos Hsi operating at a base pressure of 10⁻⁸ torr. Samples were prepared by drop-casting a dilute organic solution of the nanoparticles onto a clean glass slide. Charge neutralization was used to reduce surface charging effects. Multiplexes of carbon, sulfur, and phosphorus were obtained by 30 scans each. Binding energies are referenced to adventitious carbon at 284.4 eV. Data were recorded with a pass energy of 20 eV. XPS spectra provides an average composition of 71% gold, 26% carbon, 2.6% phosphine, and 0.7% chlorine, corresponding to molar ratios of 18 Au: 108 C, 4.3 P:1 Cl. TGA indicates a mass ratio of 71% gold to 29% ligand, independently confirming the ligand-to-ratio determined by XPS. For direct comparison with the nanoparticles made by traditional methods, an average empirical formula was generated by assuming a core size of 55 gold atoms. Based on the average particle size, the particles produced by the method were identified as Au₁₀₁(PPh₃)_{12.5}Cl₃, in comparison with the Au₅₅(PPh₃)₁₂Cl₆ reported by Schmid. While the gold-to-phosphorus ratio matches that of the Schmid nanoparticles, the phosphorus-to-chlorine ratio of 4:1 is double that of the Schmid nanoparticles (2:1).

The reactivity of the nanoparticles to thiol ligand exchange further confirms their similarities to traditional triphenylphosphine-stabilized nanoparticles. Using previously reported methods, ligands including a number of straight-chain alkanethiol, such as straight-chain alkylthiols having 2-20 carbon chains, and charged o-functionalized alkanethiol, such as ω-carboxyalkanethiols, have been exchanged onto these nanoparticles. In each thiol-for-phosphine ligand exchange reaction, there is little change in the surface plasmon resonance of the UV/Vis spectra, indicating negligible size changes during the thiol-for-phosphine ligand exchange. Thus, the newly synthesized nanoparticles are similar in size, atomic composition, and reactivity to the Schmid preparation.

Disclosed embodiments of the method have enabled the facile formation of various nanoparticles substituted with phosphine ligands that have previously not been employed. Substitution of PR₃ for PPh₃, and slight modification of the work-up, allows for isolation of trialkylphosphine-stabilized nanoparticles in good yield. Trioctylphosphine- and tricyclohexylphosphine-stabilized gold nanoparticles have been successfully synthesized, which appear to be substantially larger by UV/Vis spectroscopy. This approach apparently is the first reported synthesis of trialkylphosphine-stabilized gold nanoparticles.

This synthesis allows for the expansion of phosphine-stabilized nanoparticle materials. Large amounts of nanoparticle material can be made in a single step using borohydride in place of diborane. Second, this synthesis allows for flexibility in the choice of phosphine ligand that was previously unknown. Variation of ligand-to-gold ratios using the disclosed embodiments can be used to achieve unprecedented size control of phosphine-stabilized gold nanoparticles.

### Example 10

This example describes a method for determining the size of the nanoparticles made using a process similar to that described in Example 9. Controlling the rate at which the reducing agent, such as sodium borohydride, is added to the reaction mixture can be used to make nanoparticles materials having desired core diameters, such as a gold core diameter (d_{core}<2 nm). The synthesis is the same in every respect as that stated in Example 9 except for the addition rate of the reducing agent (NaBH₄). In Example 9, NaBH₄ was added rapidly. In this preparation the same quantity of reducing agent was added slowly (over a period of 10 minutes) from a dropping funnel fitted with a ground glass joint and Teflon stopcock. The resultant nanoparticles were shown by UV-visible spectroscopy to have an average diameter of larger than 2 nm.

### Example 11

This example describes the synthesis of (2-mercaptoethyl)-phosphonic acid. Synthesis of (2-mercaptoethyl)-phosphonic acid: Triphenylmethanethiol (8.56 g, 30.8 mmol) was added to NaH (0.8 g, 30 mmol) in 250 mL dry THF, yielding a yellow solution. (2-bromoethyl)-phosphonic acid diethyl ester (5 mL, 38.1 mmol) was added and the solution stirred for 1 hour. The excess NaH was quenched with 25 mL of water. The resulting mixture was evaporated to ca. 20 mL, dissolved in 100 mL water and extracted with 3×150 mL CH₂Cl₂. The organic layer was concentrated by rotary evaporation and dried in vacuo for 2 hours. Upon trituration with 20 mL of diethyl ether, a white solid formed. The mixture was cooled to −78° C. and filtered. After rinsing with 25 mL of cold (−78° C.) diethyl ether, the white product, (2-tritylsulfanylethyl)-phosphonic acid diethyl ester, was dried in vacuo (10.6 g, 86% yield): ¹H NMR (300 MHz, CD₂Cl₂) δ 7.4 (m, 15H), 3.95 (m, 4H), 2.65 (m, 2H), 2.35 (m, 2H), 1.2 (t, 6H).

To remove the trityl protecting group, the product was dissolved in 50 mL of trifluoroacetic acid (TFA). Triethylsilane was added dropwise to the rapidly stirring solution until the yellow color was gone and a white solid precipitated. Once the precipitate was removed via vacuum filtration, the TFA was evaporated to yield a colorless oil. The oil was transferred to a flask equipped with a Dean Stark trap and condenser and hydrolyzed in 150 mL of refluxing 5 M HCl for 48 hours. The aqueous layer was washed with 2×100 mL of chloroform and was concentrated by rotary evaporation and dried in vacuo to yield 2-mercaptoethyl phosphonic acid, an off-white solid (2.9 g, 73% overall yield): ¹H NMR (300 MHz, D₂O) δ 2.75 (m, 2 H), 2.08 (m, 2H).

### Example 12

This example describes patterning of silicon oxide surfaces and forming nanoparticle arrays on the patterned surface. One embodiment of this approach is illustrated below:

1.5 nm triphenylphosphine (TPP) stabilized particles (Hutchison, J. E.; Foster, E. W.; Warner, M. G.; Reed, S. M.; Weare, W. W. In Inorg. Syn.; Buhro, W., Yu, H., Eds., 2004; Vol. 34, pp 228, which is incorporated herein by reference) were dissolved in dichloromethane and stirred with one mass equivalent of (2-mercaptoethyl)-phosphonic acid dissolved in water. When the organic layer was nearly colorless (ca. 24 hours), the aqueous layer was separated and washed with 2×100 mL dichloromethane. Any excess dichloromethane was removed by rotary evaporation at room temperature. The phosphonic acid particles were then purified by diafiltration (10 kD membrane, Spectrum Laboratories, Inc.). Nanoparticles were considered pure when no free ligand was evident by ¹H NMR. Following diafiltration, the aqueous nanoparticle solution was passed through a 0.4 μm syringe filter and lyophilized to dryness. To make up the soaking solutions for nanoparticle deposition, the nanoparticles must be dissolved in pure water first and diluted with methanol to the desired concentration (2.5 mg/mL; 3:1 methanol:water).

Silicon substrates were cleaned prior to use for 10 minutes in piranha (5:1, H₂SO₄:H₂O₂) at 90° C., followed by 10 minutes in 200:4:1 H₂O:H₂O:NH₄OH₂. For EPMA/SEM studies, Shipley 1818 photoresist was deposited by spin-coating at 5000 rpm. A photomask was used to expose 300 μm squares with UV light at 13.4 mW/s for 11 seconds. The resist was developed in Shipley Microposit 351 for 1 minute and rinsed with nanopure water. The film was then treated with oxygen plasma with 30 sccm of oxygen at 150 W RF power for 8 seconds to remove photoresist residue, and rinsed with water. The exposed silicon was functionalized with Hf⁺⁴ in an aqueous 5 mM solution of HfOCl₂ for 3 days at 50° C. The substrates were sonicated in acetone to dissolve the photoresist, and rinsed with copious amounts of water and acetone. The substrates were then soaked in a solution of phosphonic acid-functionalized nanoparticles for five days at room temperature. Substrates for TEM were prepared as above excluding the photolithography steps. The samples were polished to electron transparency by mounting on a tripod polisher with Crystal Bond and thinned with diamond lapping paper.

TEM was performed at 120 KV accelerating voltage on a Philips CM-12 microscope. EPMA data collection was performed using a Cameca SX-50. Intensities were measured on 4 wavelength dispersive spectrometers (WDS) using gas flow proportional detectors with P-10 (90% Ar, 10% methane) gas. Background subtraction was accomplished using off-peak and/or mean atomic number (MAN) calibration. (Donovan, J. J.; Tingle, T. N. J. Microsc. Soc. Am. 1996, 2, 1.) Quantitative interference corrections were performed according to the method developed by Donovan, et al. (Donovan, J. J.; Snyder, D. A.; Rivers, M. L. Microbeam Anal 1993, 2, 23.).

As described above, the silicon substrates were cleaned prior to use. In one embodiment the surface is treated prior to use to increase surface silanol concentration. Increased surface silanol concentration allows the coupling of a greater concentration of hafnium. The density of hafnium deposition is monitored by XPS measurement of Hf:Si ratio. A higher Hf 4f:Si 2p ratio indicates a surface silanol concentration.

In one embodiment, a silicon wafer is subjected to an oxygen plasma treatment followed by a wet chemical treatment to remove organic contaminants from the surface. After this treatment the wafers are ready for treatment with HfOCl₂ and subsequent processing as described above. In certain examples the oxygen plasma treatment is at about 150 mbar to about 500 mBar at 400 W for 120 seconds. In one embodiment the wet chemical treatment involves holding wafers in a solution of 200 parts H₂O to 4 parts 30% H₂O₂ to 1 part 25% NH₄OH 60° C. for 24 hours following the plasma treatment.

### Example 13

This example describes the functionalization of a gold substrate. In this assembly strategy, gold substrates are first ozone treated and then soaked in a 5 mM solution of HfCl₄ in methanol. Upon removal from the hafnium solution, the substrates are rinsed with nanopure water for 15 minutes and then soaked in a 1 mM ethanolic solution of octadecylphosphonic acid (ODPA). Control experiments were also performed where the gold substrate was immediately placed in the ODPA soaking solution after ozone treatment. After soaking for at least 24 hours, the resulting substrates were characterized with contact angle goniometry, PM-IRRAS, and x-ray photoelectron spectroscopy (XPS).

ODPA monolayers formed directly on gold yielded a static contact angle of 82±30, whereas the contact angle measured for ODPA monolayers formed on gold with the hafnium linker was 105±2°. This measurement is in good agreement with the static contact angle measured for ODPA monolayers on other substrates, including TiO₂ (104±2°).

With reference to FIG. 3, PM-IRRAS data shows two major peaks for ODPA assemblies deposited directly onto gold as well as monolayers formed on gold with a hafnium linker. The two peaks at 2922 cm⁻¹ and 2851 cm⁻¹ correspond to the CH₂ (asym) and CH₂ (sym) peaks, respectively. The shoulder of the CH₂ (asym) peak at 2959 cm⁻¹ corresponds to the CH₃ (asym) peak. These peak positions are in good agreement with the IR spectra observed for ODPA monolayers on other substrates. The fact that the spectra for ODPA on gold are within experimental uncertainty indicates that the presence (or absence) of the hafnium linker has no impact on the organization/orientation of the resulting ODPA monolayer.

The XPS data for ODPA monolayers formed on gold with and without the hafnium linker provide atomic concentration quantification (summarized in the table below). No phosphorus is observed for ODPA assemblies formed on gold without a hafnium linker present, indicating that any ODPA present on these substrates is below the detection limit of the instrument. The XPS data for ODPA assemblies formed on hafnium modified gold show the presence of hafnium, phosphorus, oxygen and a significant amount of carbon. The gold peak is also significantly attenuated. These data indicate that an ODPA monolayer has formed on the hafnium modified gold.

Atomic Quantification of XPS Data for ODPA Monolayers Formed on Gold with and without a Hafnium Linker:

| Monolayer | Au (4f) | P (2p) | C (1s) | O (1s) | Hf (4f) |
|---|---|---|---|---|---|
| ODPA on gold | 59 | 0 | 33 | 5 | — |
| ODPA on hafnium | 22 | 6 | 58 | 10 | 2 |
| modified gold | | | | | |

The contact angle, PM-IRRAS, and XPS data all indicate the presence of a high quality ODPA monolayer on hafnium modified gold. The contact angle and XPS data for the ODPA deposited on bare gold suggests that no monolayer is formed, however the PM-IRRAS data indicate the presence of a monolayer structure. Taken together, these data indicate that this example demonstrates that high quality phosphonate monolayers can be formed on gold using a hafnium linker molecule.

### Example 14

This example describes an embodiment of a method wherein the bifunctional molecule 2-mercaptoethylphosphonic acid (2-MEPA) is assembled on a gold substrate that has been patterned with hafnium. Zirconium is subsequently deposited on the exposed phosphonate groups for visualization using ToF-SIMS.

Scheme 2 outlines this process embodiment. With reference to Scheme 2, a clean gold film is patterned by photolithography to expose areas of the surface. The patterned film is briefly treated with oxygen plasma to remove any remaining resist from the exposed areas, and the substrate is subsequently soaked in an aqueous solution of HfOCl₂. The photoresist is then stripped with acetone, and the substrate is soaked in a solution of 2-MEPA. After rinsing with copious amounts of ethanol the substrate is soaked in an aqueous solution of ZrOCl₂ to mark the regions where the phosphonic acid functionality of 2-MEPA is exposed.

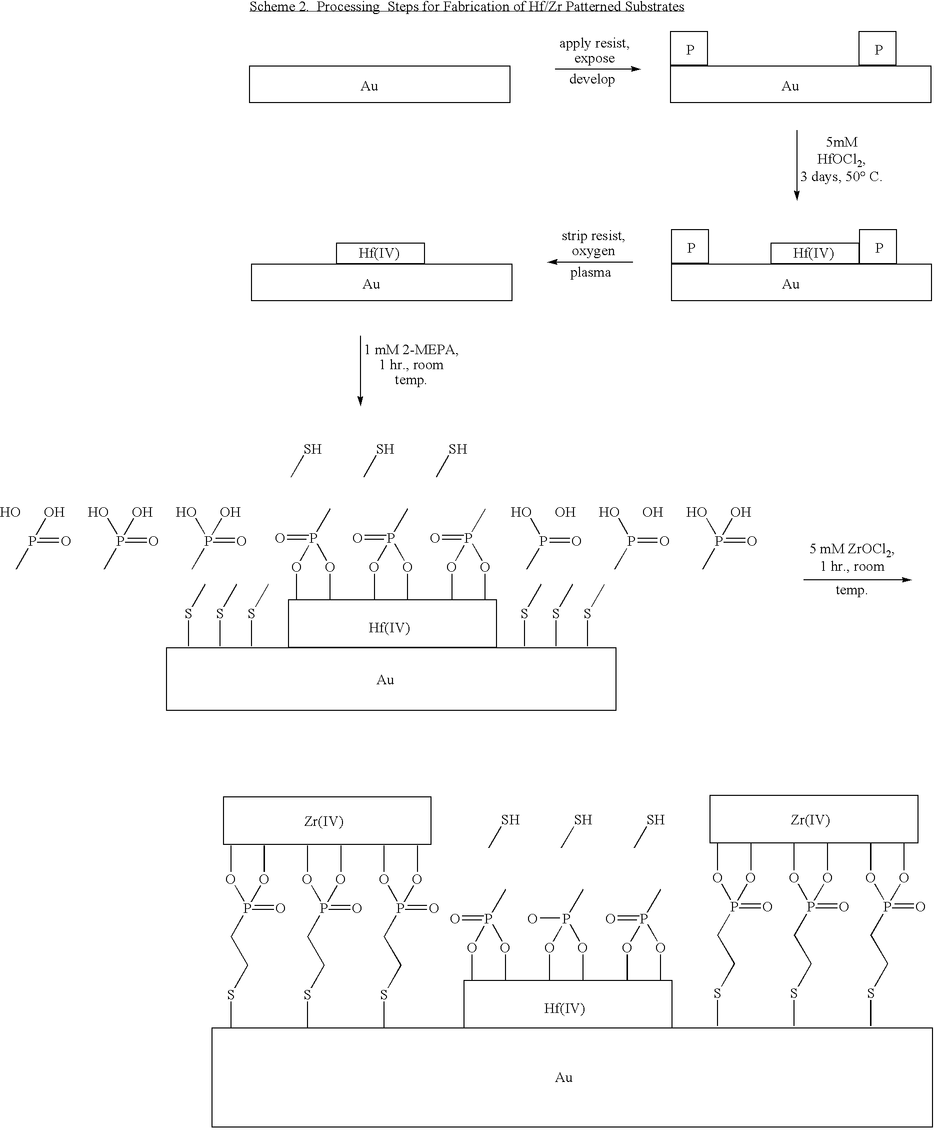

The final structures were imaged by time-of-flight secondary ion mass spectrometry (ToF-SIMS). ToF-SIMS provide ion yields of the HfO, ZrO, S and PO₃ fragments rendering the patterning of hafnium and zirconium clearly visible. The ion yields of PO₃ and sulfur also reflect the difference in orientation of 2-MEPA between the hafnium functionalized areas and the bare gold. This example further demonstrates that high quality, stable alkylphosphonate monolayers can be assembled on gold using a hafnium linker molecule, opening up the possibility of functionalizing gold surfaces with a new class of organic monolayers, and demonstrates the production of patterned gold surfaces according to embodiments of the disclosed method.

The present invention has been described with reference to preferred embodiments. Other embodiments of the invention will be apparent to those of ordinary skill in the art from a consideration of this specification, or practice of the invention disclosed herein. It is intended that the specification and examples be considered as exemplary only, with the true scope and spirit of the invention being indicated by the following claims.

1. A nanoparticle array, comprising:
an oxidized substrate;
an oxophilic metal deposited on the oxidized substrate; and
a nanoparticle coupled to the substrate via the oxophilic metal.

2. The array of claim 1, wherein the oxidized substrate comprises a metal selected from aluminum, copper, gold, silver, titanium and combinations thereof.

3. The array of claim 1, wherein the oxidized substrate comprises silicon oxide.

4. The array of claim 1, wherein the oxophilic metal comprises hafnium, zirconium, titanium or combinations thereof.

5. The array of claim 1, further comprising a linker linking the nanoparticle to the oxophilic metal.

6. The array of claim 5, wherein the linker is a bifunctional linker molecule.

7. The array of claim 5, wherein the linker comprises a phosphonate moiety.

8. The array of claim 5, wherein the linker comprises at least one sulfur atom.

9. The array of claim 5, wherein the linker has the formula 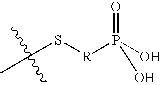
wherein R comprises an aliphatic or aromatic group.

10. The array of claim 9, wherein R represents a lower alkyl group.

11. The array of claim 9, wherein R comprises an aryl group.

12. The array of claim 9, wherein R comprises a phenyl or biphenyl moiety.

13. The array of claim 9, wherein R represents —CH₂CH₂—, —CH₂CH₂OCH₂CH₂— or —CH₂CH₂OCH₂CH₂OCH₂CH₂—.

14. The array of claim 1, wherein the nanoparticle comprises gold.

15. The array of claim 1, wherein the nanoparticle has a d_{core} of less than about 2 nanometers.

16. The array of claim 1, wherein the nanoparticle has a d_{core} of less than about 1.5 nanometers.

17. The array of claim 1, wherein the nanoparticle is an Au₁₁ nanoparticle.

18. The array of claim 1, further comprising plural nanoparticles coupled to the substrate.

19. The array of claim 18, wherein the plural nanoparticles are substantially monodisperse.

20. A method for functionalizing an oxidized surface, comprising:
providing the oxidized surface;
contacting the oxidized surface with an oxophilic metal, thereby depositing the oxophilic metal on the oxidized surface; and
attaching a nanoparticle to the oxophilic metal.

21. The method of claim 20, wherein providing the oxidized surface comprises contacting a substrate with an oxidizing agent.

22. The method of claim 21, wherein the oxidizing agent is ozone.

23. The method of claim 20 wherein the oxidized surface comprises silicon, copper, silver, gold or a combination thereof.

24. The method of claim 20, wherein the oxophilic metal is hafnium, titanium or zirconium.

25. The method of claim 20, wherein contacting the oxidized surface with an oxophilic metal comprises contacting the surface with a hafnium halide.

26. The method of claim 25, wherein the hafnium halide comprises HfCl₄, HfOCl₂, or both.

27. The method of claim 20, further comprising patterning resist on the oxidized surface.

28. The method of claim 27, wherein the resist is patterned prior to contacting the surface with the oxophilic metal.

29. The method of claim 28, wherein the resist is removed after contacting the surface with the oxophilic metal, thereby producing a chemically patterned surface.

30. The method of claim 29, wherein attaching a nanoparticle to the oxophilic metal forms a two-dimensional nanoparticle film.

31. A nanoparticle array, comprising:
a substrate comprising gold;
an oxophilic metal deposited on the oxidized substrate; and
a nanoparticle coupled to the substrate via the oxophilic metal.

32. The nanoparticle array of claim 31, wherein the oxophilic metal comprises hafnium.
